(19) United States
(12) Patent Application Publication
(10) Pub. No.: US 2011/0271876 A1
(43) Pub. Date: Nov. 10, 2011

(54) GEOPOLYMER COMPOSITIONS

(76) Inventors: Stephen Alter, Wirrel (GB); Michael Wright, Wirrel (GB)

(21) Appl. No.: 13/143,717

(22) PCT Filed: Jan. 8, 2010
(86) PCT No.: PCT/IB10/00011

§ 371 Date: Jul. 7, 2011

(30) Foreign Application Priority Data
Jan. 9, 2009 (NZ) 574113

(51) Int. Cl. C04B 7/14; B29C 39/02; C04B 18/06

(52) U.S. Cl. 106/707; 106/789; 106/790; 264/122

(57) ABSTRACT

The present invention relates to geopolymer compositions, methods of producing the compositions, and uses thereof. The geopolymer compositions broadly are comprised of a geopolymer binder and an aggregate and, once cured, can exhibit compressive strengths in excess of that of Portland cement-based concrete formulations. The geopolymer composition of the present invention adheres to most surfaces and can b used in the formation of a mortarless building block, floor screed, bench, building block brick, support column or pre-molded column, beam, paving stone, tiles, stone accouterment for a garden, countertop, bathtub, sink, a geopolymer slab, a structural geopolymer composition, a reinforced geopolymer composition, a steel reinforced geopolymer composition, or as a substitute for structural concrete in foundations, beams, columns, or slab with the addition as necessary of steel reinforcement.

The present invention relates to geopolymer compositions suitable for production on a large or industrial scale and for use as a building material.

### BACKGROUND OF THE INVENTION

Portland cement has long been a standard building material. Over the years, various modifiers have been developed for Portland cement-based concrete formulations to provide particular properties or advantages, such as rapid curing; compatibility with or resistance to certain materials; and varying strengths. However, modified Portland cement-based concrete formulations frequently result in products with undesirable properties. For example, a Portland cement-based concrete formulation which initially cures rapidly results in a final product with a lower strength, whereas a higher strength Portland cement-based concrete formulation lacks sufficient early strength and therefore cannot be de-molded (removal of the mold from the cement without slumping, sagging, or deforming) for substantial periods of time.

In addition, a key disadvantage of Portland cement-based concrete formulations is shrinkage of the resulting concrete. Shrinkage is a time-dependant decrease in concrete volume compared with the original placement volume of concrete. Shrinkage results from physical and chemical changes that occur in the paste fraction of concrete. The two principal types of shrinkage are plastic and drying shrinkage. Plastic shrinkage occurs while concrete is in the plastic state. Drying shrinkage occurs after concrete has reached initial set. Technically, drying shrinkage will continue for the life of the concrete, but most shrinkage occurs within the first 90 days after placement.

Recently, geopolymers have been developed as a potential alternative to Portland cement-based concrete formulations. The term “geopolymer” was originally used by Josef Davidovits (Davidovits, J (1994) “High-Alkali Cements for 21st Century Concretes. in Concrete Technology, Past, Present and Future”, Proceedings of V. Mohan Malhotra Symposium, Editor: P. Kumar Metha, ACI SP-144, 383-397) who proposed that an alkaline liquid could be reacted with silicon and aluminum in a source material of geological origin, or in by-product materials such as fly ash and rice husk ash, to produce binders. Because the chemical reaction that takes place is a polymerisation process, he coined the term ‘geopolymer’ for these binders.

Geopolymers are members of the family of inorganic polymers. The chemical composition of a geopolymer material is similar to natural zeolitic materials, but the microstructure is amorphous. The polymerisation process involves a substantially fast chemical reaction under alkaline conditions on Si—Al minerals that results in a three-dimensional polymeric chain and ring structure consisting of Si—O—Al—O bonds.

Geopolymer compositions have been used as a replacement for Portland cement-based concrete formulations. Some of the presently known geopolymer compositions, such as those developed by Davidovits, utilise metakaolin as the source of silica and aluminium in the geopolymer. Using metakaolin is not a feasible option in large scale construction due to its high cost (˜£1400/tonne). The geopolymers of the prior art are therefore not suitable for scale up or manufacture on an industrial scale.

For example, WO 2008/048617 discusses compositions and methods for generating concrete compounds. The concrete compounds reported therein use amorphous silica, metakaolinite, and/or diamataceous earth. All of these components are very expensive and the concrete compounds of WO 2008/048617 are therefore not suitable for industrial application. Similarly, the geopolymeric gelled materials of CN 11172826 use metakaolins and are unsuitable for industrial applications.

When a geopolymer polymerises or “cures”, water is released. This water, expelled from the geopolymer matrix during the curing and further drying periods, leaves behind discontinuous nano-pores in the matrix. These provide benefits to the performance of geopolymers, such as increased resistance to acid when compared to Portland cement-based concrete formulations.

The water in a geopolymer mixture, therefore, plays no role in the chemical reaction that takes place; it merely provides workability to the mixture during handling. In contrast, water is essential to the hydration reaction in a Portland cement-based concrete mixture and most Portland cement-based concrete formulations must be kept covered with water to enable the curing process to occur.

WO 2008/048617 and WO 2008/012438 both discuss using comparatively large amounts of water in the concrete compositions discussed therein. The applicant has found that higher amounts of water actually weakens and fundamentally changes the characteristics of a geopolymer composition.

Some of the previously reported geopolymer compositions require heating to cure the composition to provide high compressive strength. For example, WO 2008/012438 reports that the mechanical properties of the geopolymer compositions depend on alkalinity and setting temperature. This specification discusses that the geopolymer composition must be heated to at least 90° C. in order to achieve a compressive strength of 65 MPa to 70 MPa. The geopolymer compositions of US 2009/0229493 also reportedly require heating to 50° C. in order to achieve high compressive strength. WO 2009/0229493 also discusses that when the temperature is increased, the compressive strength increases.

Similarly, WO 2008/048617 discusses alkali activated material (earth concrete) and slag based concrete compositions. This specification discusses using 40 to 95% aggregate (rock) for earth concrete, but only provides examples with approximately 50% aggregate. This specification also discusses that in order to achieve higher aggregate ratios the aggregate or binder must be heated and cured at approximately 90° C.

WO 2008/048617 also discusses that when the aggregate in the earth concrete is present at 20%, a compressive strength of 10 MPa was achieved. When the aggregate was increased to 40%, the compressive strength was reported to be 24 MPa. But when the aggregate was increased to 60%, the compressive strength dropped to 15 MPa and for 80% of aggregate the compressive strength was reportedly 12 MPa.

The slag based concrete of WO 2008/048617 also reportedly comprises an aggregate of 40 to 50%. In order to use a higher percentage of aggregate the aggregate in the slag based concrete of WO 2008/048617 is heated.

Heating the aggregate is not practical on an industrial scale and increases the cost of the final geopolymer compositions significantly. There is thus a need for a geopolymer composition that has high compressive strength that does not also need heating to obtain that strength.

It is thought that inside the discontinuous nano-pores, polymerisation continues to grow silicon, aluminium and oxygen polymer chains which completely fill the nano-pores with increasing strength as the polymerisation occurs. Once polymerisation has occurred, water cannot be reabsorbed into the geopolymer composition.

Increasing the amount of water in the geopolymer composition increases the amount of shrinkage of the final geopolymer composition. WO 2008/048617 discusses heating the formed concrete compounds at 90° C. to remove any water and to minimize shrinkage. Again the use of heating during the curing process to minimize shrinkage is difficult and expensive to undertake on an industrial scale.

Geopolymers, though mineral in composition, have many of the properties of molding resins, such as epoxides and polyurethanes. Examples of such geopolymers are described in EP 1801804, CZ 0291443, WO 03/040054, U.S. Pat. No. 4,349,386, and U.S. Pat. No. 4,472,199. These patent specifications discuss geopolymers which are primarily composed of silica and alumina, and also discuss methods to provide specific geopolymeric structures. However, the geopolymers known in the art do not result in a product that has the aesthetics of natural stone or a geopolymer that is suitable for industrial application.

Some reported geopolymer compositions, such as those from US 2008/0302276, combine Portland cement-based concrete formulations with geopolymer compositions to increase the setting times and hydraulic properties of the resultant combinations.

Other geopolymer compositions of the prior art, such as those from CN1138859, are said to look similar to stone, but require the geopolymer composition to cure under vacuum with vibration. There is therefore a need to provide a geopolymer composition that has the aesthetics of natural stone that is cured under ambient conditions.

WO 03/040054 discusses using a geopolymer composition as a façade to a concrete block and utilizes residual rock or naturally faded rock and/or detrital rock coming from erosion as the aggregate. The aggregate is combined with a geopolymer binder that is originally discussed in FR 2,666,253. The combination, which may also include a pigment, is then cured. In some cases heating is required to cure the compositions. The compressive strength of the geopolymer binder of FR 2,666,253 is between 2 and 30 MPa and is provided by prohibitively expensive materials, such as, silica dust. In addition, the geopolymer binder of FR 2,666,253 contains a large amount of carbon, which would weaken and adversely color the final geopolymer composition once set. The geopolymer composition of, for example, WO 2009/024829 and WO 2008/012438 discuss using predominantly fly ash as the main ingredient (˜50%) in the geopolymer compositions. There is no discussion of the Loss On Ignition (LOI) of the fly ash used in WO 2009/024829 and WO 2008/012438, but in any case, such a high proportion of fly ash would adversely color and weaken the resulting geopolymer compositions.

Adhesion to a surface is a very important property in a building material, for example, Portland cement-based concrete adheres to steel to provide a reinforced concrete with increased strength. The geopolymer compositions of WO 2008/048617 reportedly does not adhere to steel, cardboard, wood, plastic, and the like.

At present, geopolymers are mainly developed and used in a laboratory environment and on small scale projects, but have yet to be used on an industrial scale due to the factors discussed above. Thus, there is a need for alternatives to existing geopolymers, particularly ones that can be used on a large or industrial scale.

The present invention therefore aims to provide a useful alternative to known geopolymer or cementitious compositions.

### STATEMENT OF INVENTION

The geopolymer composition of the invention has been developed to not only mimic natural stone with variable strength, but also to produce a cheaper alternative to Portland cement-based concrete formulations that can be used on an industrial scale and other known geopolymer compositions.

In a first aspect, the present invention provides a geopolymer composition comprising:
a) from about 1 to about 30 parts by weight blast furnace slag;
b) from about 1 to about 60 parts by weight of bauxite (calcined or not calcined), alumina slag or tailings, or powdered alumina oxide;
c) from about 1 to about 40 parts by weight dry sodium silicate or sodium silicate premixed with water to produce a suspension of about 25% to about 50% of solids, or about 1 to about 40 parts of dry potassium silicate or potassium silicate premixed with water to produce a suspension of about 25% to about 50% of solids;
d) from about 1 to about 40 parts by weight of a dry base, or if premixed with water, as a solution of about 25% to about 50% by weight of the solids;
e) from about 0.01 to about 5 parts by weight of a plasticizer;
f) from about 1 to about 60 parts by weight of water;
g) from about 0.05 to about 30 parts by weight of calcite; and
h) from about 40 to about 90 parts by weight of quarried, crushed, and/or milled stone.

The geopolymer composition of the invention may optionally further comprise one or more of:
i) from about 0 to about 60 parts by weight fly ash with a Loss On Ignition (LOI) of 0%;
j) from about 0 to about 40 parts by weight of amorphous silica;
k) from about 0 to about 60 parts by weight of lime;
l) from about 0 to about 60 parts by weight of gypsum sulfate;
m) from about 0 to about 10 parts by weight of a coloring agent; and/or
n) from about 0 to about 25 parts by weight of a retarder.

In another aspect, the present invention provides a method for producing a geopolymer composition as described above, comprising:
thoroughly mixing components a) to f) to provide a first wet mix;
optionally adding components i) to n) to the first wet mix and mixing until the components are thoroughly mixed;
adding components g) and h) and mixing until the components g) and h) are thoroughly coated with the first wet mix to provide a second wet mix;
pouring the second wet mix into an area or a mold;
allowing the geopolymer composition to polymerise; and optionally
de-molding.

In a further aspect, the present invention provides the method as described above which results in a geopolymer composition with greater compressive strength than standard Portland cement-based concrete formulations.

In another aspect, the present invention provides the use of the geopolymer composition as described above as a mortarless building block.

In a further aspect, the present invention provides the use of the geopolymer compositions as described above as a floor screed.

In a further aspect, the present invention provides the use of the geopolymer composition as described above when poured into a mold. The mold can be in the form of a bench, traditional building block, brick, support column or pre-molded column, beam, paving stone, tiles, stone accouterment for a garden, countertop, bathtub, sink, carving, corbel, decorative mullion, lintel, or the like.

In a further aspect, the present invention provides the use of the geopolymer compositions as described above as a slab, such as a slab suitable for a building.

In a further aspect, the present invention provides the use of a geopolymer composition as a substitute for structural concrete in foundations, beams, columns, and slabs with the addition as necessary of steel reinforcement.

Further aspects of the invention, which should be considered in all its novel aspects, will become apparent from the following description.

### DETAILED DESCRIPTION OF THE INVENTION

According to the present invention it has been surprisingly found that a geopolymer composition can be formed from relatively inexpensive materials, and one that is suitable for use on a large or industrial scale. The geopolymer composition of the present invention can have high compressive strength, does not shrink, nor does it absorb water. In addition, the geopolymer compositions of the present invention have the “aesthetics of natural stone”.

What is meant by “aesthetics of natural stone” is that the resulting geopolymer composition or product can be manufactured and finished to have the look, feel, texture, and general appearance of natural stone, that is, sandstone, limestone, granite, and the like. The geopolymer composition of the invention can replicate natural stone and the full spectrum of colors as found in nature can be replicated, for example, from white limestone to black granite. The geopolymer compositions of the invention have also been designed to have varying compressive strengths from about 20 N/mm² to greater than about 96 N/mm² to suit a wide range of building product applications.

The geopolymer composition of the invention comprises:
a) from about 1 to about 30 parts by weight blast furnace slag;
b) from about 1 to about 60 parts by weight of bauxite (calcined or not calcined), alumina slag or tailings, or powdered alumina oxide;
c) from about 1 to about 40 parts by weight dry sodium silicate or sodium silicate premixed with water to produce a suspension of about 25% to about 50% of solids, or about 1 to about 40 parts of dry potassium silicate or potassium silicate premixed with water to produce a suspension of about 25% to about 50% of solids;
d) from about 1 to about 40 parts by weight of a dry base, or if premixed with water, as a solution of about 25% to about 50% by weight of the solids;
e) from about 0.01 to about 5 parts by weight of a plasticizer;
f) from about 1 to about 60 parts by weight of water;
g) from about 0.05 to about 30 parts by weight of calcite; and
h) from about 40 to about 90 parts by weight of quarried, crushed, and/or milled stone.

The skilled person will appreciate that other components can be incorporated into the geopolymer composition without departing from the inventive concept. In particular, the geopolymer composition may optionally further comprise one or more of:
i) from about 0 to about 60 parts by weight fly ash with a LOI of 0%;
j) from about 0 to about 40 parts by weight of amorphous silica;
k) from about 0 to about 60 parts by weight of lime;
l) from about 0 to about 60 parts by weight of gypsum sulfate;
m) from about 0 to about 10 parts by weight of a coloring agent; and/or
n) from about 0 to about 25 parts by weight of a retarder.

Any suitable high pH base may be used as component d). A person skilled in the art of cementitious or geopolymer compositions would be able to determine and select an appropriate base as known in the art. However, in a preferred embodiment of the present invention the base is selected from the group comprising sodium hydroxide, potassium hydroxide, soda ash, or pot ash.

Plasticizers are used in the production of Portland cement-based concrete formulations to increase the plasticity or fluidity of the formulations, enable a reduction in the water content (which would normally increase the strength of Portland cement-based concrete formulations), improve the dispersal of the materials in the mix, and increase the consistency and workability of the formulation. Any additive that improves the consistency and workability of the geopolymer composition would fall into the category of a plasticizer for the purposes of the present invention and may be, for example, selected from, but not limited to, the group comprising: lignosulphate based plasticisers (such as sulphonated naphthalene condensate), melamine formaldehyde, polycarboxylate ethers, polycarboxylate, or other commercially available plasticizers (such as Armcon AP300™, Armplus Super XWR™ or Adva 500™) or the like.

Most industrially produced sodium silicate or water glass that is suitable for geopolymer compositions is manufactured on a ratio of silica sand:soda ash (or sodium hydroxide) of 3:1 or 2:1. The resulting sodium silicate is then filtered to remove any impurities and results in a sodium silicate of approximately 39 to 50% solids. The sodium silicate that may be used in the present invention may be obtained from such an industrial process. However, unfiltered sodium silicate with a ratio of sodium silicate to soda ash (or sodium hydroxide) of 2:1 preferably may be used. Such an unfiltered 2:1 sodium silicate with 60% solids is preferred. A 2:1 sodium silicate with 60% solids will have an approximate pH of 11 to 14 when in solution.

The use of an unfiltered sodium silicate also enables the reduction of the amount of dry base in the geopolymer composition.

Thus in a preferred embodiment of the invention, sodium silicate with a ratio of sodium silicate to soda ash of 2:1 and at least 60% solids is used as component c).

White bauxite is preferred as component b) due to the lack of iron present in the bauxite. Thus in a preferred embodiment of the present invention, component b) is white bauxite.

Ground granulated blast furnace slag is obtained by quenching molten iron slag (a by product of iron and steel manufacture) from a blast furnace in water or steam to produce a glassy granular product that is then dried and ground into a fine powder. Preferably, the blast furnace slag is ground to less than about 100 μm. Even more preferably, the blast furnace slag is ground to less than about 75 μm. In particular, the blast furnace slag is ground to less than about 50 μm.

In a preferred embodiment, the geopolymer composition has the aesthetics of natural stone.

The compressive strength of the geopolymer composition of the invention can be varied as desired. Because the present invention can be used as a replacement for Portland cement-based concrete formulations, it would generally be desirable for the geopolymer composition of the invention to have greater compressive strength than a similar Portland cement-based concrete formulation. The upper strength of standard Portland cement-based concrete formulations is approximately 48 N/mm². High strength Portland cement-based concrete formulations with various additives for use in exceptional circumstances, such as blast shelters or nuclear reactor shields, achieves a compressive strength of up to approximately 96 N/mm². However, the cost of high strength Portland cement-based concrete formulations prevents its use in most general applications.

In order to produce a higher compressive strength geopolymer composition the components a) to h) are mixed. Components a) to f) are used to form the binder for the high compressive strength geopolymer composition. The polymerisation process starts when the binder is mixed with components g) and h). Specifically, when component g), the calcite, is added as seed crystals, the polymerisation process is started. It is thought that the calcite acts as seed crystals for the formation of dendrites from the binder to the calcite and stone filler (component g)). A dendrite is a crystal that develops with a typical multi-branching tree-like form. Dendritic crystal growth is very common and, for example, can be illustrated by snowflake formation and frost patterns on a window. This process is exothermic.

In a preferred embodiment of the present invention, the calcite is crystalline.

In a preferred embodiment, the geopolymer composition has greater compressive strength than standard Portland cement-based concrete formulations. Further, in a preferred embodiment of the invention the geopolymer composition may have a compressive strength of greater than about 60 N/mm² after 28 days. Even more preferably, a compressive strength of greater than about 75 N/mm² may be obtained after 28 days. Even more preferably, a compressive strength of greater than about 95 N/mm² may be obtained after 28 days.

In order to produce a lower compressive strength geopolymer composition, further components i) to n) may be added to the first wet mix. Higher quantities of water, plasticizers, and the use of less binder all contribute to the reduced compressive strength of the resulting geopolymer composition. It is thought that the addition of the optional components i) to n) and further water may retard the exothermic reaction and prevent the initial growth of dendrites. Increasing the amount of fly ash with an LOI of greater than 0% (component i)) was specifically found to decrease the compressive strength of the resulting geopolymer composition.

It is also desirable to have a low compressive strength geopolymer composition that may be used to produce an alternative to Portland cement-based concrete formulations. This is because not only can a lower compressive strength geopolymer composition be produced relatively inexpensively, but also it is not always necessary to have a geopolymer composition which has a high compressive strength, for example, for producing a synthetic stone for use in a decorative garden wall.

Thus, in a preferred embodiment the geopolymer composition has a compressive strength after 28 days of about 15 to about 60 N/mm².

In a preferred embodiment, component b) is milled to less than about 250 μm, preferably, less than about 200 μm, even more preferably less than about 100 μm, and in particular less than about 50 μm.

In a preferred embodiment, component g) may be ground to less than about 3 mm, even more preferably less than about 2 mm, even more preferably less than about 1 mm, and in the most preferred embodiment less than about 500 μm.

The stone in component h) can be present in relatively large amounts when compared to the compositions of the prior art, for example, WO 2008/048617.

The geopolymer composition of the present invention has a minimum of approximately 70% to 90% aggregate (rock) and no heating is required during the curing process to achieve a high strength geopolymer composition.

In a preferred embodiment, the stone in component h) may be selected from limestone, granite, or sandstone.

The geopolymer composition, once cured, oxidises over time to become the same color and appearance as the stone used in component h).

The table below details approximate possible constituents of fly ash. Fly ash is one of the residues generated in the combustion of coal and is generally captured from the chimneys of coal fired power plants.

Normal range of chemical composition for fly ash produced from different
coal types (expressed as percent by weight).

| Component | Bituminous | Subbituminous | Lignite |
|---|---|---|---|
| SiO₂ | 20-60 | 40-60 | 15-45 |
| Al₂O₃ | 5-35 | 20-30 | 10-25 |
| Fe₂O₃ | 10-40 | 4-10 | 4-15 |
| CaO | 1-12 | 5-30 | 15-40 |
| MgO | 0-5 | 1-6 | 3-10 |
| SO₃ | 0-4 | 0-2 | 0-10 |
| Na₂O | 0-4 | 0-2 | 0-6 |
| K₂O | 0-3 | 0-4 | 0-4 |
| LOI | 0-15 | 0-3 | 0-5 |

A suitable fly ash for use in the present invention may have 30 to 60% SiO₂, 15 to 35 Al₂O₃, and 0% Loss On Ignition (LOI). Those components of fly ash which disappear when ignited are predominantly carbon or organic in nature. In the most preferred embodiment the geopolymer composition includes a fly ash with a LOI of 0%. The use of such a fly ash results in a geopolymer composition that has the appearance of natural stone.

Most fly ash used in the concrete industry has 0.05 to 3% LOI and needs to be reprocessed to reduce the LOI by removing carbon and organic components so as not to color the final product.

The higher the percentage of the LOI, the darker the final color of the geopolymer composition, for example, the color of the geopolymer composition may be in the range of light blue/grey to dark blue/grey and even black. If a darker geopolymer composition is desired, then the fly ash from component i) can include varying amounts of carbon, i.e. it has a LOI greater than about 0% to 3%.

In some cases a geopolymer composition that replicates a different colored stone may be desired. The use of other coloring agents provides geopolymer compositions of different colors. The determination of which coloring agents to use in the geopolymer composition of the invention would be known, or could easily be determined, by one skilled in the art of geopolymer or cementitious compositions. Examples of suitable coloring agents for use in the present invention include metal oxide based color pigments. Suitable metal oxides include iron oxide for red, chromium oxide for green, ultramarine or cobalt for the color blue, or manganese oxide for the color black. The metal oxides and other coloring agents can be used independently or together to provide a spectrum of colors.

The initial color of the second wet mix is a blue/green color, but this color is dependent on the specific components used in the geopolymer composition. The finished geopolymer composition, once cured, has the appearance and aesthetics of natural stone. It can be polished or other suitable finishes employed as with natural stone.

In a preferred embodiment, component j) may be in the form of ash from rice husk or micro silica. Rice husk ash has an average soluble silica content of approximately 47% to 97%. If ash from rice husk is used as a replacement for component i), then ash from rice husk with a 0% LOI is preferred.

The method of the invention for producing a geopolymer composition as described above comprises:
thoroughly mixing components a) to f) to provide a first wet mix;
optionally adding components i) to n) to the first wet mix and mixing until the components are thoroughly mixed;
adding components g) and h) and mixing until the components g) and h) are thoroughly coated with the first wet mix to provide a second wet mix;
pouring the second wet mix into an area or a mold;
allowing the geopolymer composition to polymerise; and optionally
de-molding.

In the method of the invention, the components a) to f), and optionally components i) to n), must be thoroughly premixed to form a first wet mix. The stone filler and calcite (components h) and g) respectively) are then added to the first wet mix to give a second wet mix. The components g) and h) have been quarried, crushed, and/or milled to the desired size. Components g) and h) are not calcined.

The mixture of components a) to f), and optionally components i) to n), to form a first wet mix is a strongly exothermic process that must be thoroughly mixed until the components are thoroughly coated. The stone filler and calcite (components h) and g) respectively) are then added to the first wet mix and the mixture thoroughly mixed until the components are thoroughly coated to give a second wet mix which may be used directly as a molding material or may be poured into an appropriate area.

In preferred embodiment of the method of the invention, the first and second wet mixes are mixed for at least about 4, 5, 6, 7, 8, 9, 10, 15, 20, 30, 45, 60, 120, 180, 320 minutes, or until the components are thoroughly coated and mixed.

In preferred embodiment of the method of the invention, the first and second wet mixes are mixed for at least about 4 to 5, 4 to 6, 4 to 7, 4 to 8, 4 to 9, 4 to 10, 4 to 15, 4 to 20, 4 to 30, 4 to 45, 60, 4 to 120, 4 to 180, 4 to 320 minutes, or until the components are thoroughly coated and mixed.

The geopolymer composition of the invention can also be de-molded relatively quickly after the composition has been poured. This is not possible with Portland cement-based concrete formulations, which require a significant amount of time before de-molding can occur. It is thought that the reaction between the binder (components a) to f)) and calcite (component g)) accounts for the relatively short de-molding time. This is because of the exothermic nature of the process which negates the need to heat the geopolymer during curing to achieve necessary compressive strengths and to decrease the de-molding time.

The geopolymer composition of the invention is able to polymerise at an ambient temperature of about 15 to about 25° C. This feature cannot be replicated in existing geopolymer compositions, as they cannot polymerise in this temperature range. Most geopolymer compositions require heating in order to accelerate the polymerisation process and thus enable early de-molding. Further, existing geopolymer compositions often take days to achieve sufficient hardness to enable de-molding below about 30° C.

Thus, in a preferred embodiment of the method of the invention, the polymerisation occurs at about 15 to about 25° C.

In a preferred embodiment of the method of the invention, demolding may occur about five hours after pouring, even more preferably about four hours after pouring, more preferably about three hours after pouring, and even more preferably about two hours after pouring.

In some cases, it may be preferable that the geopolymer composition of the invention has a long curing time, i.e. de-molding does not occur for a substantial period of time. In order to extend the time before de-molding could occurs, components k) to n) may be added in varying amounts to the geopolymer composition. The amount of water in the composition may also be increased to increase the setting time.

In addition to the required materials detailed above, other materials may be added to the geopolymer composition, for example, retarders, as commonly used by one skilled in the art in cement formulations, such as, an acid, gypsum, boron or a boron containing compound, such as the ore Borax, or an appropriate substitute therefor, or water. Any suitable acid could be used as a retarder for the purposes of the present invention, such as citric or sulfuric acid.

The uses of the geopolymer composition of the present invention include the forming of a mortarless building block, floor screed, bench, building block, brick, support column or pre-molded column, beam, paving stone, tiles, stone accouterment for a garden, countertop, bathtub, sink, a geopolymer slab, a structural geopolymer composition, a reinforced geopolymer composition, a steel reinforced geopolymer composition, carving, corbel, decorative mullion, lintel or the like.

The use of natural stone as a building material is desirable as it provides an aesthetically pleasing finish to a building as well as being very strong. However, natural stone requires a highly skilled stone mason to select, carve, and lay each individual stone. Present cementitious compositions cannot replicate the appearance of natural stone.

Therefore, the present invention provides a geopolymer composition which has the appearance of stone, but can be poured like existing cementitious compositions. Such compositions do not require a skilled mason to pour and can be polished just like natural stone.

The geopolymer composition of the invention can be used to form mortarless building blocks. Mortarless building blocks are building blocks that do not use mortar to bind the bricks or blocks together. Mortarless building blocks, such as the Haener® building block, fit together like Lego® blocks. A cement or filler is poured down a center cavity to bind the building blocks together. This gives the blocks greater strength. Mortarless building blocks have a shear strength approximately 10 times stronger than traditional building blocks or bricks that use mortar to bind the blocks or bricks together. Geopolymer derived mortarless building blocks result in a product with all the aesthetics of stone, but that does not require a skilled mason to install or lay the blocks. The use of mortarless blocks primarily assists the erection of buildings quickly and cheaply. In addition, the mortarless blocks provide buildings with higher compression and tensile strength suitable for use in earthquake zones or high risk areas.

The geopolymer composition of the invention can also be poured inside the mortarless building blocks. This use of the geopolymer composition of the invention inside mortarless building blocks is advantageous over Portland cement-based concrete formulations as it does not shrink. If the filling material inside the blocks shrinks, a weakened structure can develop, as well as cracks and leaks, none of which are desirable.

The use of granite, limestone, sandstone, or any natural stone in residential housing is desirable because of its inherent aesthetics and strength. The use of such natural stone is relatively, and can be prohibitively, expensive. The geopolymer composition of the present invention can be used to mimic the appearance of natural stone and can replace the use of natural stone in residential housing. The geopolymer composition of the invention could be used to form a bench, building block, brick, support column or pre-molded column, beam, paver, tile, stone accouterment for a garden, countertop, bathtub, sink, carving, corbel, decorative mullion, lintel, or the like.

Adhesion to a surface is a very important property in a building material, for example, Portland cement-based concrete adheres to steel to provide a reinforced concrete with increased strength. The geopolymer composition of the invention adheres to almost any surface, such as steel, cardboard, plastic, wood, and the like, with the exception of releasing agents.

Portland cement-based concrete formulations can be strengthened with the addition of steel reinforcing (rebars). Such reinforced Portland cement-based concrete formulations have greater compressive strength and more importantly they can withstand greater shear forces than non-reinforced Portland cement-based concrete formulations. Since the geopolymer composition of the invention adheres to steel, it can also be reinforced with steel. The geopolymer composition of the invention can also, therefore, be used to replace structural concrete as a building material. Further, the reinforced geopolymer composition can be used to replace high strength, or very high strength concrete.

The geopolymer composition of the invention is also resistant to acid degradation and is hydrophobic.

This invention may also be said to broadly consist in parts, elements, and features referred to or indicated in this specification, individually, or collectively, or any or all combinations of any two or more said parts, elements, or features. Where specific integers are mentioned herein that have known equivalents in the art to which the invention relates, such known equivalents are deemed to be incorporated herein as if individually set forth.

Example formulations of the present invention include:

A geopolymer composition comprising:
a) about 16 to about 18 parts blast furnace slag ground to about 15 to about 25 μm;
b) about 0.99 to about 18 parts of calcined bauxite ground to about 10 to about 25 μm;
c) about 6 to about 8 parts sodium silicate solution (pH 13), about 39% to about 60% by volume solids;
d) about 1 to about 5 parts sodium hydroxide 50/50 solution with water;
e) about 0.99 to about 1.01 parts of commercial grade super plasticizer;
f) about 1 to about 20 parts of water;
g) about 8 to about 10 parts calcite ground to less than about 500 μm;
h) about 25 to about 40 parts Cotswold stone ground to less than about 500 μm;
h) about 21 to about 36 parts Cotswold stone ground to less than about 6 mm; and
n) about 0.99 to about 25 parts of calcined or not calcined borax, or an appropriate substitute therefor, (a retarder).

A geopolymer composition comprising:
a) about 15 to about 17 parts blast furnace slag powdered to about 15 to about 25 μm;
b) about 0.99 to about 18 parts calcined bauxite ground to about 10 to about 25;
c) about 7 to about 9 parts sodium silicate solution (pH 13), about 39% to about 60% by volume solids;
d) about 7 to about 9 parts potassium hydroxide 50/50 solution with water;
e) about 1.99 to about 2.01 parts of commercial grade super plasticizer;
f) about 0.99 to about 29 parts of water;
g) about 7 to about 9 parts calcite ground to less than about 500 μm;
h) about 15 to about 25 parts Cotswold stone ground to less than about 500 μm;
h) about 32 to about 42 parts Cotswold stone ground to less than about 6 mm; and
n) about 0.99 to about 25 parts of calcined or not calcined borax, or an appropriate substitute therefor, (a retarder).

A geopolymer composition comprising:
a) about 5 to about 7 parts blast furnace slag powdered to about 15 to about 25 μm;
b) about 0.99 to about 18 parts calcined bauxite ground to about 10 to about 25 μm;
c) about 7 to about 9 parts sodium silicate solution (pH 13), about 39% to about 60% by volume solids;
d) about 3 to about 20 parts flaked potash;
e) about 0.99 to about 1.01 parts of commercial grade super plasticizer;
f) about 2 to about 20 parts of water;
g) about 7 to about 9 parts calcite ground to less than 500 μm;
h) about 15 to about 25 parts Cotswold stone ground to less than about 500 μm; and
h) about 39 to about 46 parts Cotswold stone ground to less than about 6 mm; and
n) about 0.99 to about 25 parts of calcined or not calcined borax, or an appropriate substitute therefor, (a retarder).

A geopolymer composition comprising:
a) about 5 to about 7 parts blast furnace slag ground to about 10 to about 25 μm;
b) about 0.99 to about 20 parts calcined bauxite ground to about 10 to about 25 μm;
c) about 5 to about 7 parts sodium silicate solution (pH 13), about 39% to 60% by volume solids;
d) about 3 to about 5 parts soda ash solution with water maximum saturation of about 60% solids;
e) about 0.99 to about 1.01 parts of commercial grade super plasticizer;
f) about 1 to about 20 parts of water;
g) about 7 to about 9 parts calcite ground to less than about 500 μm;
h) about 5 to about 15 parts Cotswold stone ground to less than about 500 μm;
h) about 46 to about 56 parts Cotswold stone ground to less than about 6 mm;
i) about 0.99 to about 14 parts powdered fly ash with an LOI of 0% ground to about 3 to about 25 μm; and
n) about 0.99 to about 25 parts of calcined or not calcined borax, or an appropriate substitute therefor, (a retarder).

A geopolymer composition comprising:
a) about 5 to about 7 parts blast furnace slag ground to about 10 to about 25 μm;
b) about 0.99 to about 18 parts calcined bauxite ground to about 10 to about 25 μm;
c) about 7 to about 9 parts sodium silicate solution (pH 13), about 39% to about 60% by volume solids;
d) about 3 to about 5 parts flaked potash;
e) about 0.99 to about 1.01 parts of commercial grade super plasticizer;
f) about 2 to about 20 parts of water;
g) about 7 to about 9 parts calcite ground to less than about 500 μm;
h) about 5 to about 15 Cotswold stone ground to less than about 500 μm;
h) about 46 to about 56 parts Cotswold stone ground to less than about 6 mm;
i) about 10 to about 30 parts powdered fly ash with a LOI of 0% LOI ground to about 3 to about 25 μm; and
n) about 0.99 to about 25 parts of calcined or not calcined borax, or an appropriate substitute therefor, (a retarder).

A geopolymer composition comprising:
a) about 5 to about 7 parts blast furnace slag ground to about 10 to about 25 μm;
b) about 0.99 to about 18 parts calcined bauxite ground to about 10 to about 25 μm;
c) about 7 to about 9 parts sodium silicate solution (pH 13), about 39% to about 60% by volume solids;
d) about 3 to about 20 parts soda ash;
e) about 0.99 to about 1.01 parts of commercial grade super plasticizer;
f) about 2 to about 20 parts of water;
g) about 7 to about 9 parts calcite ground to less than about 500 μm;
h) about 5 to about 15 Cotswold stone ground to less than about 500 μm;
h) about 46 to about 56 parts Cotswold stone ground to less than about 6 mm;
i) about 10 to about 30 parts powdered fly ash with a LOI of 0% LOI ground to about 3 to about 25 μm; and
n) about 0.99 to about 25 parts of calcined or not calcined borax, or an appropriate substitute therefor, (a retarder).

A geopolymer composition comprising:
a) about 5 to about 7 parts blast furnace slag ground to about 10 to about 25 μm;
b) about 0.99 to about 18 parts calcined bauxite ground to about 10 to about 25 μm;
c) about 7 to about 9 parts sodium silicate solution (pH 13), about 39% to about 60% by volume solids;
d) about 3 to about 20 parts soda ash;
e) about 0.99 to about 1.01 parts of commercial grade super plasticizer;
f) about 2 to about 20 parts of water;
g) about 7 to about 9 parts calcite ground to less than about 500 μm;
h) about 5 to about 15 Cotswold stone ground to less than about 500 μm;
h) about 46 to about 56 parts Cotswold stone ground to less than about 6 mm;
i) about 10 to about 30 parts powdered fly ash with a LOI of 0% ground to about 3 to about 25 μm; and
n) about 0.99 to about 15 parts of sulfuric acid (a retarder).

A geopolymer composition comprising:
a) about 5 to about 7 parts blast furnace slag ground to about 10 to about 25 μm;
b) about 0.99 to about 18 parts calcined bauxite ground to about 10 to about 25 μm;
c) about 7 to about 9 parts sodium silicate solution (pH 13), about 39% to about 60% by volume solids;
d) about 3 to about 20 parts soda ash;
e) about 0.99 to about 1.01 parts of commercial grade super plasticizer;
f) about 2 to about 20 parts of water;
g) about 7 to about 9 parts calcite ground to less than about 500 μm;
h) about 5 to about 15 Cotswold stone ground to less than about 500 μm;
h) about 46 to about 56 parts Cotswold stone ground to less than about 6 mm;
i) about 10 to about 40 parts powdered fly ash with a LOI of 0% LOI ground to about 3 to about 25 μm; and
n) about 0.99 to about 25 parts of calcined or not calcined borax, or an appropriate substitute therefor, (a retarder).

A geopolymer composition comprising:
a) about 5 to about 7 parts blast furnace slag ground to about 10 to about 25 μm;
b) about 0.99 to about 18 parts calcined bauxite ground to about 10 to about 25 μm;
c) about 7 to about 9 parts sodium silicate solution (pH 13), about 39% to about 60% by volume solids;
d) about 3 to about 8 parts potassium hydroxide;
e) about 0.99 to about 1.01 parts of commercial grade super plasticizer;
f) about 2 to about 20 parts of water;
g) about 7 to about 9 parts calcite ground to less than about 500 μm;
h) about 5 to about 15 Cotswold stone ground to less than about 500 μm;
h) about 46 to about 56 parts Cotswold stone ground to less than about 6 mm;
i) about 10 to about 30 parts powdered fly ash with a LOI 0% ground to about 3 to about 25 μm; and
n) about 0.99 to about 25 parts of calcined or not calcined borax, or an appropriate substitute therefor, (a retarder).

A geopolymer composition comprising:
a) about 5 to about 7 parts blast furnace slag ground to about 10 to about 25 μm;
b) about 0.99 to about 18 parts calcined bauxite ground to about 10 to about 25 μm;
c) about 7 to about 9 parts sodium silicate solution (pH 13), about 39% to about 60% by volume solids;
d) about 3 to about 20 parts soda ash;
e) about 0.99 to about 1.01 parts of commercial grade super plasticizer;
f) about 2 to about 20 parts of water;
g) about 7 to about 9 parts calcite ground to less than about 500 μm;
h) about 5 to about 15 Cotswold stone ground to less than about 500 μm;
h) about 46 to about 56 parts Cotswold stone ground to less than about 6 mm;
i) about 10 to about 30 parts powdered fly ash with a LOI of 0% ground to about 3 to about 25 μm; and
n) about 0.99 to about 25 parts of calcined or not calcined borax, or an appropriate substitute therefor, (a retarder).

A geopolymer composition comprising:
a) about 5 to about 7 parts blast furnace slag ground to about 10 to about 25 μm;
b) about 0.99 to about 18 parts calcined bauxite ground to about 10 to about 25 μm;
c) about 7 to about 9 parts sodium silicate solution (pH 13), about 39% to about 60% by volume solids;
d) about 3 to about 20 parts soda ash;
e) about 0.99 to about 1.01 parts of commercial grade super plasticizer;
f) about 2 to about 20 parts of water;
g) about 7 to about 9 parts calcite ground to less than about 500 μm
h) about 5 to about 15 Cotswold stone ground to less than about 500 μm;
h) about 46 to about 56 parts Cotswold stone ground to less than about 6 mm;
i) about 10 to about 30 parts powdered fly ash with a LOI of 0% ground to about 3 to about 25 μm; and
n) about 0.99 to about 25 parts of calcined or not calcined borax, or an appropriate substitute therefor, (a retarder).

A geopolymer composition comprising:
a) about 5 to about 7 parts blast furnace slag ground to about 10 to about 25 μm;
b) about 0.99 to about 18 parts calcined bauxite ground to about 10 to about 25 μm;
c) about 7 to about 9 parts sodium silicate solution (pH 13), about 39% to about 60% by volume solids;
d) about 3 to about 8 parts of sodium hydroxide;
e) about 0.99 to about 1.01 parts of commercial grade super plasticizer;
f) about 2 to about 20 parts of water;
g) about 7 to about 9 parts calcite ground to less than about 500 μm
h) about 5 to about 15 Cotswold stone ground to less than 500 about μm;
h) about 46 to about 56 parts Cotswold stone ground to less than about 6 mm;
i) about 10 to 30 about parts powdered fly ash with a LOI of 0% ground to about 3 to about 25 μm; and
n) about 0.99 to about 25 parts of calcined or not calcined borax, or an appropriate substitute therefor, (a retarder).

The invention consists in the foregoing and also envisages constructions of which the following gives examples only.

### EXAMPLES

Each of Examples 1 to 4 was tested by an independent laboratory. The test involved mixing a geopolymer composition of the invention and pouring a test cube of 100 mm in length/height/depth. The test cubes were then left to cure at ambient temperature for approximately 3, 7, 21, and 28 days, and then subjected to compressive testing. Each cube was kept dry for the full curing duration.

Each cube was cast in the summer months in England where the ambient temperature is 15 to 25° C.

Cotswold stone is a limestone.

### Example 1

The following components were mixed for at least 4 minutes to give a first wet mix.
a) 16 to 18 parts (400 g) blast furnace slag powdered to approximately 48 μm;
b) 0.99 to 1.01 parts (20 g) calcined bauxite milled to approximately 48 μm;
c) 6 to 8 parts (150 g) sodium silicate solution (pH 11), 39% by volume solids;
d) 3 to 5 parts (80 g) sodium hydroxide 50/50 solution with water;
e) 0.99 to 1.01 parts (20 g) of commercial grade super plasticizer; and
f) 1 to 3 parts (50 g) of water.

After the first wet mix is mixed, components g) and h) are added and mixed for at least 4 minutes to give a second wet mix. Component h) was composed of quarried and ground Cotswold stone.
g) 8 to 10 (200 g) calcite ground to less than about 500 μm; and
h) 59 to 61 parts (1400 g) Cotswold stone ground to less than about 6 mm.

The setting time was approximately 30 minutes. The test block was initially blue/green in color.

Within 28 to 40 days the test cubes oxidised to the Cotswold natural stone color. The strength of the material was not affected by the oxidation. After 28 days the cubes would not absorb water.

### Example 2

The following components were mixed for at least than 4 minutes to give a first wet mix.
a) 15 to 17 parts (400 g) blast furnace slag powdered to approximately 48 μm;
b) 0.99 to 1.01 parts (20 g) calcined bauxite milled to approximately 48 μm;
c) 7 to 9 parts (200 g) sodium silicate solution (pH 11), 39% by volume solids;
d) 7 to 9 parts (200 g) potassium hydroxide 50/50 solution with water;
e) 1.99 to 2.01 parts (40 g) of commercial grade super plasticizer; and
f) 0.99 to 1.01 parts (25 g) of water.

After the first wet mix is mixed, components g) and h) are added and mixed for at least 4 minutes to give a second wet mix. Component h) was composed of quarried and ground Cotswold stone.
g) 7 to 9 parts (200 g) calcite ground to less than about 500 μm; and
h) 55 to 57 parts (1400 g) Cotswold stone ground to less than about 6 mm.

The setting time was approximately 30 minutes. The test blocks were initially blue/green in color.

Within 28 to 40 days the test cubes oxidized to the Cotswold natural stone color. The strength of the material was not affected by the oxidation. After 28 days the cubes would not absorb water.

### Example 3

The following components were mixed for at least 4 minutes to give a first wet mix.
a) 4 to 6 parts (100 g) blast furnace slag powdered to approximately 48 μm;
b) 0.99 to 1.01 parts (20 g) calcined bauxite milled to approximately 48 μm;
c) 5 to 7 (150 g) sodium silicate solution (pH 11), 39% by volume solids;
d) 3 to 5 parts (80 g) sodium hydroxide 50/50 solution with water;
e) 0.99 to 1.01 parts (20 g) of commercial grade super plasticizer;
f) 2 to 4 parts (75 g) of water; and
i) 11 to 13 parts (300 g) powdered fly ash with 0% LOI.

After the first wet mix is mixed, components g) and h) are added and mixed for at least 4 minutes to give a second wet mix. Component h) was composed of quarried and ground Cotswold stone.
g) 7 to 9 parts (200 g) calcite ground to less than about 500 μm; and
h) 59 to 61 parts (1400 g) Cotswold stone ground to less than about 6 mm.

The setting time was approximately 30 minutes. The test block was initially blue/green in color.

Within 28 to 40 days the test cubes oxidised to the Cotswold natural stone color. The strength of the material was not affected by the oxidation. After 28 days the cubes would not absorb water.

### Example 4

The following components were mixed for at least 4 minutes to give a first wet mix.
a) 5 to 7 parts (150 g) blast furnace slag powdered to approximately 48 μm;
b) 0.99 to 1.01 parts (20 g) calcined bauxite milled to approximately 48 μm;
c) 5 to 7 parts (150 g) sodium silicate solution (pH 11), 39% by volume solids;
d) 3 to 5 parts (80 g) sodium hydroxide 50/50 solution with water;
e) 0.99 to 1.01 parts (20 g) of commercial grade super plasticizer;
f) 1 to 3 parts (50 g) of water; and
i) 12 to 14 parts (300 g) powdered fly ash with 0% LOI.

After the first wet mix is mixed, components g) and h) are added and mixed for at least 4 minutes to give a second wet mix. Component h) was composed of quarried and ground Cotswold stone.
g) 7 to 9 parts (200 g) calcite ground to less than about 500 μm; and
h) 59 to 61 parts (1400 g) Cotswold stone ground to less than about 6 mm.

The setting time was approximately 30 minutes. The test block was initially blue/green in color.

Within 28 to 40 days the test cubes oxidised to the Cotswold natural stone color. The strength of the material was not affected by the oxidation. After 28 days the cubes would not absorb water.

The compressive testing of Examples 1 to 4 is shown in Table 1.

TABLE 1
Compressive strengths of the test cubes from Examples 1 to 4

| Exam- | Age | Weight | Density | | Cube Strength |
|---|---|---|---|---|---|
| ple | (days) | kg | kg/m³ | Load kN | N/mm² |
| 1 | 4 | 2.296 | 2300 | 412 | 41.0 |
| | 7 | 2.308 | 2310 | 397.1 | 39.5 |
| | 14 | 2.332 | 2330 | 495 | 49.5 |
| | 28 | 2.317 | 2320 | 591 | 59.0 |
| 2 | 7 | 2.349 | 2350 | 594 | 59.5 |
| | 14 | 2.347 | 2350 | 785 | 78.5 |
| | 21 | 2.320 | 2340 | 801 | 80.0 |
| | 28 | 2.382 | 2380 | 959 | 96.0 |
| 3 | 3 | 2.304 | 2240 | 54.0 | 5.5 |
| | 3 | 2.244 | 2240 | 69.4 | 7.0 |
| | 21 | 2.287 | 2290 | 272 | 27.0 |
| | 28 | 2.138 | 2180 | 196.5 | 20.0 |
| 4 | 7 | 2.232 | 2230 | 189.4 | 19.0 |

As can be seen from the results of the compressive testing of Examples 1 to 4 the compressive strength increases over time. Example 2 provides the highest compressive strength of 96 N/mm².

The compressive strength shown in the table above demonstrates a range of strengths from 5.5 N/mm² to 52.5 N/mm² at 3 days. A strength at 28 days ranging from 20 N/mm² to 96 N/mm² is also shown in the table. It can be seen from Examples 1 to 4 above that the ingredients and relative proportions are critical in determining the final compressive strength of the geopolymer composition of the invention. This range of strengths indicates that the structural properties of the geopolymer compositions of the invention can be controlled.

Although the invention has been described by way of example, it should be appreciated that variations and modifications may be made without departing from the scope of the invention. Furthermore, where known equivalents exist to specific features, such equivalents are incorporated as if specifically referred to in this specification.

1. A geopolymer composition comprising:
a) from about 1 to about 30 parts by weight blast furnace slag;
b) from about 1 to about 60 parts by weight of bauxite (calcined or not calcined), alumina slag or tailings, or powdered alumina oxide;
c) from about 1 to about 40 parts by weight dry sodium silicate or sodium silicate premixed with water to produce a suspension of about 25% to about 50% of solids, or about 1 to about 40 parts of dry potassium silicate or potassium silicate premixed with water to produce a suspension of about 25% to about 50% of solids;
d) from about 1 to about 40 parts by weight of a dry base, or if premixed with water, as a solution of about 25% to about 50% by weight of the solids;
e) from about 0.01 to about 5 parts by weight of a plasticizer;
f) from about 1 to about 60 parts by weight of water;
g) from about 0.05 to about 30 parts by weight of calcite; and
h) from about 40 to about 90 parts by weight of quarried, crushed. and/or milled stone.

2. The geopolymer composition according to claim 1, optionally further comprising one or more of:
i) from about 0 to about 60 parts by weight fly ash with a Loss On Ignition (LOI) of 0%;
j) from about 0 to about 40 parts by weight of amorphous silica;
k) from about 0 to about 60 parts by weight of lime;
l) from about 0 to about 60 parts by weight of gypsum sulfate;
m) from about 0 to about 10 parts by weight of a coloring agent; and/or
n) from about 0 to about 25 parts by weight of a retarder.

3. The geopolymer composition of claim 1, wherein the dry base is sodium hydroxide, potassium hydroxide, soda ash, or pot ash.

4. The geopolymer composition of claim 1, wherein the sodium silicate of component c) has a ratio of sodium silicate to soda ash of 2:1 and is at least 60% solids.

5. The geopolymer composition of claim 1, wherein the ground granulated blast furnace slag is obtained by quenching molten iron slag from a blast furnace in water or steam to produce a glassy granular product that is then dried and ground into a fine powder having a particle size of less than about 100, 75, or 50 μm in diameter.

6. The geopolymer composition of claim 1, wherein component b) is ground to a particle size of less than about 250, 200, 100, or 50 μm in diameter.

7. The geopolymer composition of claim 6, wherein component b) is white bauxite.

8. The geopolymer composition of claim 1, wherein component g) is ground to a particle size of less than about 3, 2, 1 cm, or 500 μm in diameter.

9. The geopolymer composition of claim 1, wherein component h) is selected from the group comprising limestone, granite, or sandstone.

10. The geopolymer composition of claim 1, wherein the geopolymer composition, once set, has the aesthetics of natural stone.

11. The geopolymer composition of claim 2, wherein component j), if present, is in the form of ash from rice husk or micro silica.

12. The geopolymer composition of claim 11, wherein the ash from rice husk has a LOI of 0%.

13. The geopolymer composition of claim 1, wherein the calcite is crystalline.

14. The geopolymer composition of claim 1, wherein the plasticizer is selected from the group comprising lignosulphate based plasticizer, sulphonated naphthalene condensate, melamine formaldehyde, polycarboxylate ether, or polycarboxylate.

15. The geopolymer composition of claim 2, wherein the coloring agent, if present, is selected from a metal oxide based color pigment.

16. The geopolymer composition of claim 2, wherein component n), if present, is selected from the group comprising an acid, sulfuric acid, citric acid, gypsum, boron or a boron containing compound, borax, or an appropriate substitute therefor, or water.

17. The geopolymer composition of claim 1, wherein the geopolymer composition has a higher compressive strength than Portland cement-based standard concrete.

16. The geopolymer composition of claim 17, wherein the geopolymer composition has a compressive strength of greater than about 60 N/mm² after 28 days.

19. The geopolymer composition of claim 18, wherein the geopolymer composition has a compressive strength of greater than about 75 N/mm² after 28 days.

20. The geopolymer composition of claim 19, wherein the geopolymer composition has a compressive strength of greater than about 95 N/mm² after 28 days.

21. The geopolymer composition of claim 1, wherein the geopolymer composition has a lower compressive strength than Portland cement-based concrete.

22. The geopolymer composition of claim 21, wherein the geopolymer composition has a compressive strength of about 15 to about 60 N/mm² after 28 days.

23. The geopolymer composition of claim 1, wherein the geopolymer composition adheres to steel, cardboard, plastic, or wood, but does not adhere to releasing agents.

24. The geopolymer composition of claim 1, wherein the geopolymer composition, once set, is resistant to acid degradation and is hydrophobic.

25. The geopolymer composition of claim 1 comprising:
a) 16 to 18 parts blast furnace slag powdered to approximately 48 μm;
b) 0.99 to 1.01 parts calcined bauxite milled to approximately 48 μm;
c) 6 to 8 parts sodium silicate solution (pH 11), 39% by volume solids;
d) 3 to 5 parts sodium hydroxide 50/50 solution with water;
e) 0.99 to 1.01 parts of commercial grade super plasticizer;
f) 1 to 3 parts of water;
g) 8 to 10 parts calcite ground to less than 500 μm; and
h) 59 to 61 parts Cotswold stone ground to less than 6 mm.

26. The geopolymer composition of claim 1 comprising:
a) 15 to 17 parts blast furnace slag powdered to approximately 48 μm;
b) 0.99 to 1.01 parts calcined bauxite milled to approximately 48 μm;
c) 7 to 9 parts sodium silicate solution (pH 11), 39% by volume solids;
d) 7 to 9 parts potassium hydroxide 50/50 solution with water;
e) 1.99 to 2.01 parts of commercial grade super plasticizer;
f) 0.99 to 1.01 parts of water;
g) 7 to 9 parts calcite ground to less than about 500 μm; and
h) 55 to 57 parts Cotswold stone ground to less than about 6 mm.

27. The geopolymer composition of claim 1 comprising:
a) 4 to 6 parts blast furnace slag powdered to approximately 48 μm;
b) 0.99 to 1.01 parts calcined bauxite milled to approximately 48 μm;
c) 5 to 7 sodium silicate solution (pH 11), 39% by volume solids;
d) 3 to 5 parts sodium hydroxide 50/50 solution with water;
e) 0.99 to 1.01 parts of commercial grade super plasticizer;
f) 2 to 4 parts of water;
g) 7 to 9 parts calcite ground to less than 500 μm;
h) 59 to 61 parts Cotswold stone ground to less than 6 mm; and
i) 11 to 13 parts powdered fly ash with a LOI of 0%.

28. The geopolymer composition of claim 1 comprising:
a) 5 to 7 parts blast furnace slag powdered to approximately 48 μm;
b) 0.99 to 1.01 parts calcined bauxite milled to approximately 48 μm;
c) 5 to 7 parts sodium silicate solution (pH 11), 39% by volume solids;
d) 3 to 5 parts sodium hydroxide 50/50 solution with water;
e) 0.99 to 1.01 parts of commercial grade super plasticizer;
f) 1 to 3 parts of water;
g) 7 to 9 parts calcite ground to less than 500 μm;
h) 59 to 61 parts Cotswold stone ground to less than 6 mm; and
i) 12 to 14 parts powdered fly ash with a LOI of 0%.

29. A method for producing the geopolymer composition of claim 1, comprising:
thoroughly mixing components a) to f) to provide a first wet mix;
optionally adding components i) to n) to the first wet mix and mixing until the components are thoroughly mixed;
adding components g) and h) and mixing until the components g) and h) are thoroughly coated with the first wet mix to provide a second wet mix;
pouring the second wet mix into an area or a mold;
allowing the geopolymer composition to polymerise; and optionally
de-molding.

30. The method of claim 29, in which the first and second wet mixes are mixed for at least about 4, 5, 6, 7, 8, 9, 10, 15, 20, 30, 45, 60, 120, 180, or 320 minutes, or until the components are thoroughly coated and mixed.

31. The method of claim 29, in which the first and second wet mixes are mixed for at least about 4 to 5, 4 to 6, 4 to 7, 4 to 8, 4 to 9, 4 to 10, 4 to 15, 4 to 20, 4 to 30, 4 to 45, 60, 4 to 120, 4 to 180, or 4 to 320 minutes, or until the components are thoroughly coated and mixed.

32. The method of claim 29, in which the polymerisation occurs at about 15 to 25° C.

33. The method of claim 29, wherein demolding may occur about 5, 4, 3, or 2 hours after pouring the second wet mix into the area or the mold.

34. The method of claim 29, wherein the mold is in the shape of a mortarless building block, a bench, traditional building block, brick, support column or pre-molded column, beam, paving stone, tile, stone accouterment for a garden, countertop, bathtub, carving, corbel, decorative mullion, lintel or sink.

35. Use of the geopolymer composition of claim 1 as a mortarless building block, floor screed, bench, building block, brick, support column or pre-molded column, beam, paving stone, tiles, stone accouterment for a garden, countertop, bathtub, sink, a geopolymer slab, a structural geopolymer composition, a reinforced geopolymer composition, a steel reinforced geopolymer composition, or as a substitute for structural concrete in foundations, beams, columns, or a slab with the addition as necessary of steel reinforcement.

36. The use of claim 35, wherein the steel reinforced geopolymer composition replaces high strength or very high strength concrete.
